(19) United States
(12) Patent Application Publication
(10) Pub. No.: US 2010/0179880 A1
(43) Pub. Date: Jul. 15, 2010

(54) SYSTEM AND METHOD FOR PURCHASING GOODS OR SERVICES USING A GROUP COMMUNICATION FROM A WIRELESS COMMUNICATION DEVICE

(75) Inventor: Beth Ann BREWER, Canyon Lake, TX (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/351,268

(22) Filed: Jan. 9, 2009

(51) Int. Cl. G06Q 30/00; H04B 7/26

(52) U.S. Cl. 705/26; 455/518

(57) ABSTRACT

A system and method for purchasing a good and/or service through a group communication, such as a push-to-talk communication, to one or more sellers. A sellers list of the desired good or service is created using a group communication server or another computer device and sent to the wireless communication device of the user, either at the time the user wireless communication device requests to send a group communication to order a good and/or service, or prior thereto. The user may then send a group communication from the wireless communication device to the seller list requesting a desired good and/or service, and any answering seller will communicate back to the requesting wireless communication device to bid to provide the requested good and/or service.

### BACKGROUND OF THE INVENTION

1. Field of the Invention

The present invention relates to a communications across point-to-point or point-to-multipoint wireless communications systems. More specifically, the present invention relates to a system and method for utilizing a group communication network to order goods and/or services from potentially many selling entities at once.

2. Description of the Related Art

There exists a wireless telecommunication service that provides a quick one-to-one or one-to-many communication between groups of wireless communication devices, such as mobile telephones, that is generically referred to as “Push-To-Talk” (PTT) capability. The specific PTT group of recipient devices for the communicating wireless device is commonly set up by the carrier. A PTT communication connection is typically initiated by a single button-push on the wireless device that activates a half-duplex link between the speaker and each member device of the group and once the button is released, the device can receive incoming PTT transmissions. In some arrangements, the PTT speaker will have the “floor” where no other group member can speak while the speaker is speaking. Once the speaker releases the PTT button, any other individual member of the group can engage their PTT button and they will have the floor. The PTT capability allows the simultaneous, or near simultaneous, broadcasting of communications to many devices. The many receiving devices can then attempt to contact back the communication-originating device, or can communicate with the entire group of devices.

While PTT communications can be used between buyers and sellers to communicate in financial transaction, a group is required to be created in order to ensure that the group member devices include the appropriate parties. Such a group is created by the user of the PTT device and will be stored as a typical group the device, and the financial transaction group does not account for any parameters in the list of participants, such as location in relation to the originating device, price, or other financial parameters.

Accordingly, it would be advantageous to provide a system and method that can utilize the one-to-many communication capabilities of a group communication system, such as a PTT system, to engage in commerce transactions where many parties are desired to participate to optimize the transaction, and the group of potential sellers of the good and/or services can be adjusted based upon pertinent criteria. It is thus to the provision of such a system and method that the present invention is primarily directed.

### SUMMARY OF THE INVENTION

The present invention includes system and method for utilizing a group communication network to order goods and/or services from one or more sellers, such as the ability to use a push-to-talk (PTT) network of wireless communication devices to order goods or sellers from many sellers at once. A seller list of seller computer devices that opt to receive requests for the goods or services can be generated at the time the user of a device desires to purchase a good or service, or can be preloaded to the user's device. The seller list is created at a computer device on the wireless network, such as the group communication server or other device, and is sent to the requesting wireless communication device.

The present system and method are therefore advantageous in that they allow the selective ordering of goods and services through a group communication setting without the user of the communicating wireless communication device having to determine which sellers are able to provide the good or service desired. The present system may restrict the seller list based on the geographic proximity of the seller to the user of the communicating wireless communication device attempting to order the good or service. The seller list may also be created based on price of the good or service, time of day, and the availability of the seller to provide the good or service when desired by the user of the communicating wireless communication device.

Other objects, features, and advantages of the present invention will become apparent after review of the Brief Description of the Drawings, Detailed Description, and the Claims.

### BRIEF DESCRIPTION OF THE DRAWINGS

FIG. 1 is a representative diagram of one embodiment of a wireless network with a designated PTT group of wireless telecommunication devices communicating with a group communication server and other computer devices across the wireless network.

FIG. 2 is a diagram of one embodiment of a wireless network in a common cellular telecommunication configuration.

FIG. 3 is a block diagram illustrating the computer platform of the wireless telecommunication device embodied with PTT capability.

FIG. 4 is a block diagram of one embodiment of the various software layers resident on the computer platform of the wireless communication device.

FIG. 5 is a representative diagram of a wireless communication device where the seller list is selectively provided to the wireless communication device by either a group communication server or by another computer device.

FIG. 6 is a flowchart of one embodiment of a process for a wireless communication device requesting a seller list from a computer device such that the user of the wireless communication device can attempt to order a good and/or service from the provided list of sellers.

FIG. 7 is a flowchart of one embodiment of a process for a computer device receiving a request for a seller list for sellers of goods and/or services from a wireless communication device and the computer device generates a seller list and sends the seller list to the wireless communication device.

### DETAILED DESCRIPTION

In this description, the terms “communication device,” “wireless device,” “wireless communications device,” “PTT communication device,” “handheld device,” “mobile device,” and “handset” are used interchangeably. The terms “call” and “communication” are also used interchangeably. The term “application” as used herein is intended to encompass executable and non-executable software files, raw data, aggregated data, patches, and other code segments. The term “group communication” is intended to encompass a one-to-one or one-to-many half-duplex communication, including voice and/or data, performed over a half-duplex channel or a full-duplex channel having half-duplex functionality. The term “exemplary” means that the disclosed element or embodiment is only an example, and does not indicate any preference of user. Further, like numerals refer to like elements throughout the several views, and the articles “a” and “the” includes plural references, unless otherwise specified in the description. The term “or” as used herein is intended to encompass the occurrence of one, the other, or both, similarly to the term “and/or”.

Furthermore, the system 10 is shown here in several embodiments as operating in a cellular network architecture. Reference can be had to the known standards and construction of cellular systems and network interfaces as would be known to one of skill in the art. Known telecommunication standards can be used in implementation of the present system 10.

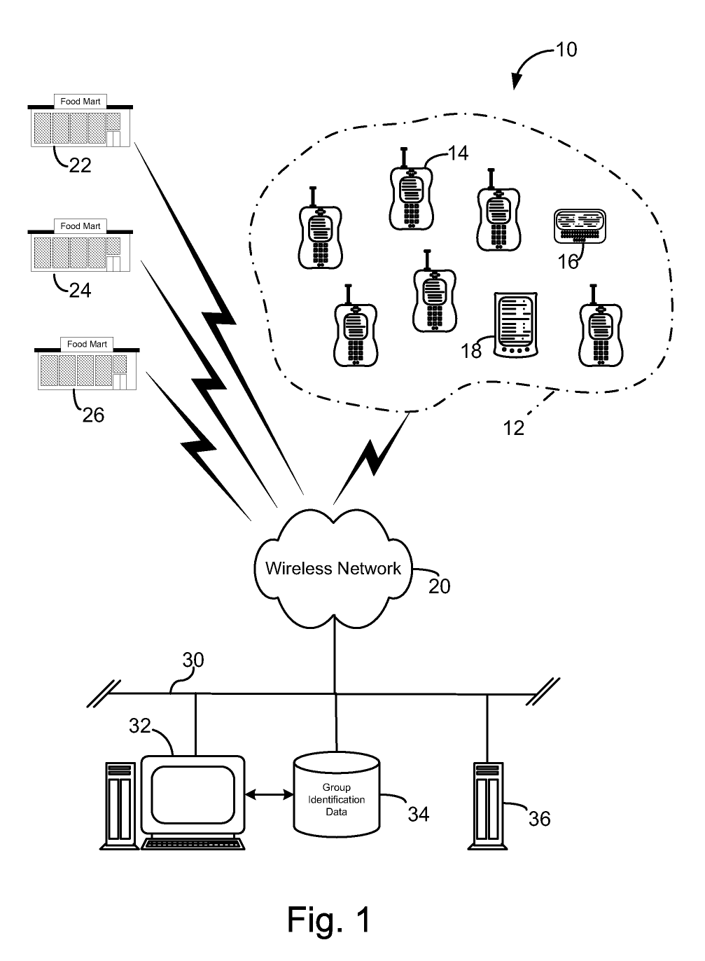

With reference to the figures in which like numerals represent like elements throughout, FIG. 1 illustrates one embodiment of a system 10 with a group communication server 32 and one or more wireless telecommunication devices in a communication group 12, such as wireless telephone 14, smart pager 16, and personal digital assistant (PDA) 18, that communicate with other wireless telecommunication devices across a wireless network 20. In the system 10, each wireless telecommunication device 14, 16, 18 is capable of selectively directly communicating across the wireless communication network 20 with a target set of one or more other wireless telecommunication devices of the plurality. For example, the target set for mobile telephone 14 can be all devices in the communication group 12 or a subset thereof, such as pager 16 and PDA 18.

In this embodiment, the wireless telecommunication device (such as mobile telephone 14) notifies the group communication computer device, shown here as group communication server 32, which is present on a server-side LAN 30 across the wireless network 20, to indicate that the wireless device is present, i.e. accessible, on the wireless network 20. The group communication computer device 32 can share this information with the set of target wireless telecommunication devices designated by the first wireless telecommunication device, or can also share the information with other computer devices resident on the server-side LAN 30 or accessible across the wireless network 20. The group communication computer device 32 can have an attached or accessible database 34 to store the group identification data for the wireless devices.

The direct communication, such as a PTT communication, can be established through a half-duplex channel between the communicating wireless telecommunication device 14, 16, 18 and the one or more other wireless telecommunication devices of the target set of devices. Also, the group communication computer device 32 can attempt to bridge the requested direct communication with the target set if at least one of the wireless telecommunication devices of the target set have informed the group communication computer device 32 of their presence on the wireless network 20.

The group communication computer device 32 can also inform the wireless telecommunication device 14, 16, 18 of the inability to bridge a direct communication to the target set 12 upon none of the wireless telecommunication devices (or at least one) of the target set not having informed the group communication computer device 32 of their presence on the wireless network 20. Further, while the group communication computer device 32 is shown here as having the attached database 34 of group identification data, the group communication computer device 32 can have group identity data resident thereupon, and perform all storage functions described herein. Also shown here is a seller list generator 36 that selectively generates seller lists comprised of seller computer devices for transmission to wireless communication device 14,16,18 that can use the seller list to send a group communication to the seller computer devices of the seller list to order and good and/or service. The seller computer devices can be wireless communication devices, such as mobile phones, and other mobile devices, or can be wired computer devices able to receive the group communication to order the good and/or service.

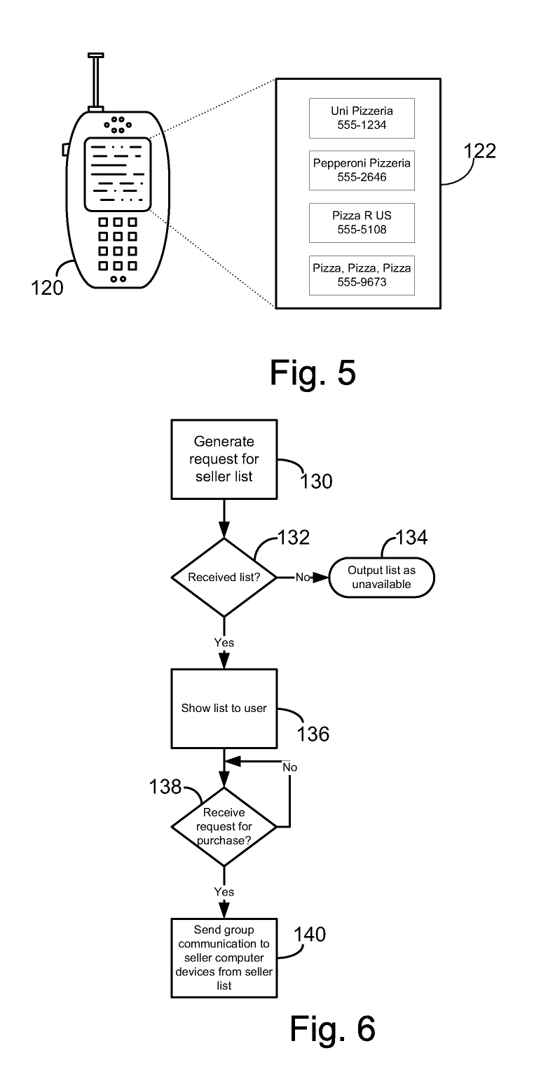

Sellers 22,24,26, and more particularly, seller computer devices that are accessible to the wireless network 20 and can communicate or at least receive group communications from wireless communication devices. As more specifically described herein, the wireless communication devices 14,16,18 can send group communications to the sellers 22,24,26 to attempt to purchase a good and/or service, with the group communication addresses or identities being provided through a seller list (122 in FIG. 5).

The group communication can be voice, applications, graphic media, such as pictures in JPEG, TIF, and the like, or audio files such as MP3, MP4, WAV, and the like. The media can also be video or streaming media, such as a multimedia application (PowerPoint, MOV file, and the like). Also, the group communication is typically half-duplex audio conferencing among members of the communication group 12. However, in the group communications, the speed of the connection and the quality of media delivery, and especially voice data, are important to maintain QoS to the end-user.

In a first embodiment, the system 10 for purchasing a good and/or service through a group communication to one or more sellers 22,24,26 computer devices. The system 10 can include the following components: a group communication server 32 configured to support group communications among a plurality of wireless communication devices 14,16,18; a wireless communication device 14 that is configured to selectively send communications to other computer devices through the group communication server 32, the one wireless devices having a user thereof, and a seller computer device that is configured to selectively receive ordering group communications from communicating wireless communication devices 14,16,18, with the ordering group communications containing information on a good or service that a user of the communicating wireless communication device desires to purchase. The wireless communication device may be further configured to receive a seller list (122 in FIG. 5) of one or more seller devices for the purchasing of a specific good or service such that if the user of the wireless communication device desires to purchase a good or service, the wireless communication device 14,16,18 may send an ordering group communication to the one or more seller devices based upon the seller list 122 for one or more sellers of that good or service.

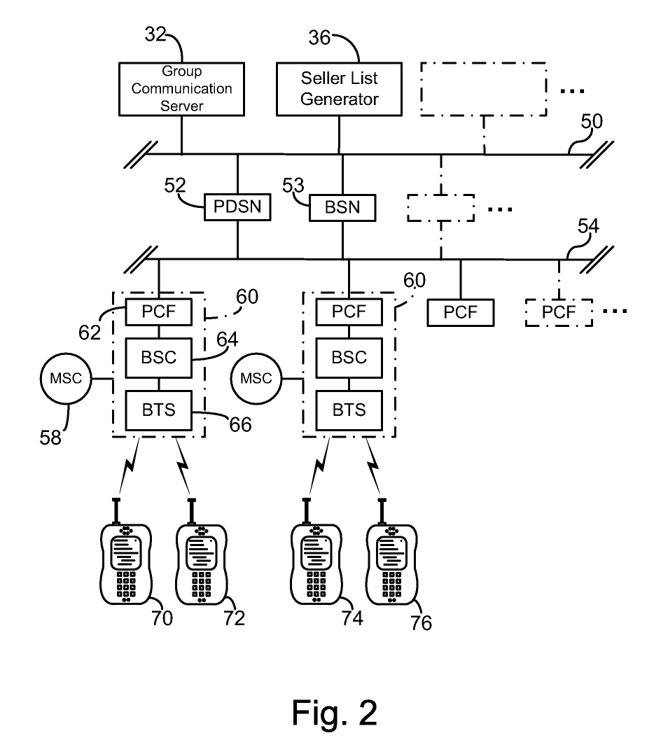

FIG. 2 is a representative diagram of one embodiment of a wireless network in a common cellular telecommunication configuration, having a series of group communication computer devices, such as group communication server 32 that controls communications between the wireless communication devices of set group members (devices 70, 72, 74, 76) in a PTT system. The wireless network is merely exemplary and can include any system whereby remote modules communicate over-the-air between and among each other and/or between and among components of a wireless network 20, including, without limitation, wireless network carriers and/or servers. A series of group communication servers 32 are connected to a group communication server LAN 50. Wireless telephones can request packet data sessions from the group communication server(s) 32 using a data service option. Also shown is the seller list generator 36 resident on the LAN 50.

The group communication server 32 is connected to a wireless service provider's packet data service node (PDSN) such as PDSN 52, and/or a broadcast serving node (BSN) 53 shown here resident as on a carrier network 54. The PDSN 52 and BSN 53 with the associated base stations 60 can constitute a regional communication system, or the further inclusion of other server side 50 components, that will control communications to the wireless communication devices 70,72,74,76 for a geographical or virtual region. Each PDSN 52 or BSN 53 can interface with a base station controller 64 of a base station 60 through a packet control function (PCF) 62. The PCF 62 is typically located in the base station 60. The carrier network 54 controls messages (generally in the form of data packets) sent to a messaging service controller (“MSC”) 58. The carrier network 54 communicates with the MSC 58 by a network, the Internet and/or POTS (“plain ordinary telephone system”). Typically, the network or Internet connection between the carrier network 54 and the MSC 58 transfers data, and the POTS transfers voice information. The MSC 58 can be connected to one or more base stations 60. In a similar manner to the carrier network, the MSC 58 is typically connected to the base transceiver station (sometimes referred to as “branch-to-source”) (BTS) 66 by both the network and/or Internet for data transfer and POTS for voice information. The BTS 66 ultimately broadcasts and receives messages wirelessly to and from the wireless devices, such as cellular telephones 70,72,74,76, by short messaging service (“SMS”), or other over-the-air methods known in the art. It should also be noted that carrier boundaries and/or PTT operator network boundaries do not inhibit or prohibit the sharing of data as described herein.

Cellular telephones and mobile telecommunication devices, such as wireless telephone 14, are being manufactured with increased computing capabilities and are becoming tantamount to personal computers and hand-held PDAs. These “smart” cellular telephones allow software developers to create software applications that are downloadable and executable on the processor of the wireless device. The wireless device, such as cellular telephone 14, can download many types of applications, such as web pages, applets, MIDlets, games and data. In wireless devices that have designated a communication group 12 (FIG. 1), the wireless communication device can directly connect with the other member of the set and engage in voice and data communication. However, all such group-direct communications may occur through, or be at the control of, the group communication server 32. All data packets of the devices do not necessarily have to travel through the group communication computer device 32 itself, but the group communication computer device 32 may be able to ultimately control the communication because it will typically be the only server-side 30 component that is aware of and/or can retrieve the identity of the members of the communication group, or direct the identity of the members of the communication group 12 to another computer device.

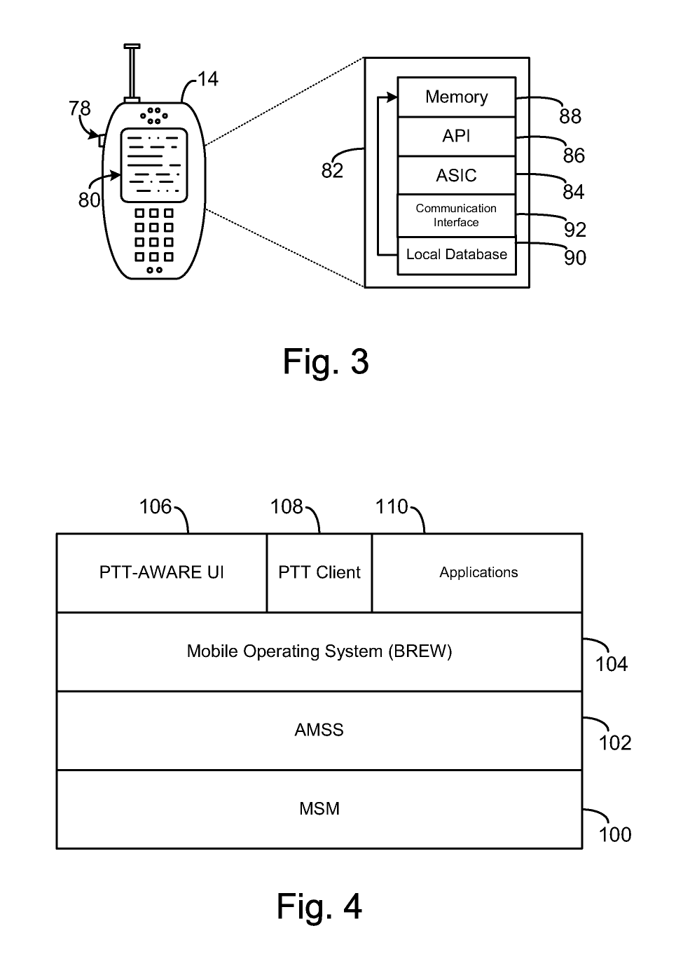

FIG. 3 is a block diagram illustrating one embodiment of the wireless telecommunication device being a mobile telephone 14 with a PTT button 78 that opens the direct communication to a target set of devices, i.e. other members of the communication group 12. The wireless device 14 is also shown as having a graphics display 80 to the user of the wireless device 14. The wireless device 14 includes a computer platform 82 that can handle voice and data packets, and receive and execute software applications transmitted across the wireless network 20 to include the group communications. The computer platform 82 includes, among other components, an application-specific integrated circuit (“ASIC”) 84, or other processor, microprocessor, logic circuit, programmable gate array, or other data processing device. The ASIC 84 is installed at the time of manufacture of the wireless device and may not normally be upgradeable. The ASIC 84 or other processor executes an application programming interface (“API”) layer 86, which includes the resident application environment, and can include the operating system loaded on the ASIC 84. The resident application environment interfaces with any resident programs in the memory 88 of the wireless device. An example of a resident application environment is the “binary runtime environment for wireless” (BREW) software developed by QUALCOMM® for wireless device platforms.

As shown here, the wireless device can be a mobile telephone 14, with a graphics display 80, but can also be any wireless device with a computer platform 82 as known in the art, such as a personal digital assistant (PDA), a pager with a graphics display 26, or even a separate computer platform that has a wireless communication portal, and may otherwise have a wired connection to a network or the Internet. Further, the memory 88 can be comprised of read-only or random-access memory (RAM and ROM), EPROM, EEPROM, flash cards, or any memory common to computer platforms. The computer platform 82 can also include a local database 90 for storage of software applications not actively used in memory 88. The local database 90 is typically comprised of one or more flash memory cells, but can be any secondary or tertiary storage device as known in the art, such as magnetic media, EPROM, EEPROM, optical media, tape, or soft or hard disk.

In this embodiment of the wireless communication device, the computer platform 82 also includes a direct communication interface 92 that can open the direct communication channel from the wireless device, typically for the half-duplex voice communication in a PTT call. The direct communication interface 92 may also be part of the standard communication interface for the wireless device which ordinarily carries the voice and data transmitted to and from the wireless device. The direct communication interface 92 typically is comprised of hardware as is known in the art.

FIG. 4 is a diagram of one embodiment of the software layers resident on the computer platform 82 of the wireless communication device 74, with a PTT facility and a group-directed communication facility. In this embodiment, the computer platform 82 in the mobile device environment consists of a series of software “layers” developed on top of the Mobile Station Modem (MSM) 100 and the Advanced Mobile Subscriber Software (AMSS) 102, developed by QUALCOMM®, drives the underlying MSM chipset and implements the software protocol stack for the entire suite of CDMA communication technologies that include CDMA2000 1× and CDMA2000 1×EV-DO. There is a mobile operating system layer 104, which in this embodiment is BREW®, also developed by QUALCOMM. The mobile operating system layer 104 application programming interfaces for chip- or device-specific operations, while providing an isolation layer that eliminates direct contact to the AMSS 100 and any OEM software on the computer platform. The mobile operating system layer 104 enables application development that uses mobile device features without having to rewrite the application each time a new release of the device-specific software is released.

The PTT Client 108 is an application that offers access to PTT services through an external interface, here shown at a PTT-aware UI 106. The PTT Client includes all the functions required to enable mobile operating system 104 applications, such as the other resident applications 110. In addition to providing access to PTT services with the PTT Client 108, the PTT Client 108 can act as an isolation layer between all PTT-aware applications and the interface to the group communication computer device 102. In this embodiment, the PTT Client 108 maintains access to PTT services, responds to group communication requests, processes all PTT-aware mobile operating system applications requests for PTT services, processes all outgoing PTT requests, collects and packages vocoder packets for originating PTT talk spurts, and parses packets of vocoder data for terminated PTT talk spurts.

In one embodiment, a handler will provide direct access to the external communication interface, or here, an AMSS 102 interface. The media handler responds to PTT requests for group-directed services by invoking the appropriate APIs, such as those from other resident applications 110, and can service the requests from the user and informs the user the result of any group-directed media request. The handler can be invoked to have the AMSS 102 interface brought to an active state and ready to broadcast on the network, as is more fully described herein. Thus, the AMSS 102 or other communication interface typically has a dormant state and active state such that resources are only requested from the wireless communication network in the active state of the communication interface, e.g. the device components are powered-up and ready to transmit.

As illustrated by FIG. 5, the seller list 122 is selectively provided to the wireless communication device 122 by the group communication server 32, i.e. the cellular provider's server(s); or the seller list 122 is selectively provided to the wireless communication device by another computer device, i.e. from a third party hired to provide the seller list 122, such as seller list generator 36. In other embodiments, a group communication server 32 is configured to support group communications among a plurality of wireless communication devices 14,16,18 and creates a list of seller computer devices from which to purchase a good or a service based upon, including, but not limited to: geographic proximity of a seller to the user of the communicating wireless communications device attempting to order the good or service, price, the time of day, and the availability. For instance, if at 10:00 pm on a Wednesday the user wants a large pizza with three toppings (pepperoni, mushrooms and bell peppers) for $8.99 delivered in 30 minutes, only the contact information of the pizza restaurants that are open past 10:00 pm that are in a certain mile distance from the user who can get deliver the pizza in 30 minutes, have all three toppings available at the time of the order, are willing to accept a charge of $8.99 for a large three topping pizza, and have the capacity to fill the order will be provided to the user.

FIG. 6 is a flowchart of one embodiment of a process for a wireless communication device 14,16,18 requesting a seller list 122 from a computer device such that the user of the wireless communication device 14,16,18 can attempt to order a good and/or service from the provided list of sellers. The wireless communication device 14,16,18 generates a request for a seller list 122, as shown at step 130, and then a determination is made as to whether the seller list 122 has been received as shown at decision 132. If the seller list 122 has not been received at decision 132, the an error is output to the user stating that the list is unavailable and the process terminates, as shown at terminator 134.

Otherwise, if the seller list 122 has been received at decision 132, then the received seller list 122 is shown to the user, as shown at step 136, and then a decision is made as to whether the user has sent, and the device has received, a request for a group communication to effect a purchase, as shown at decision 138. If then request has not been received at decision 138, then the process enters a wait state at decision 138. Otherwise, if a request for a group communication to effect a purchase has been received at decision 138, then a group communication to the seller computer devices is sent based upon the seller list 122, as shown at step 140.

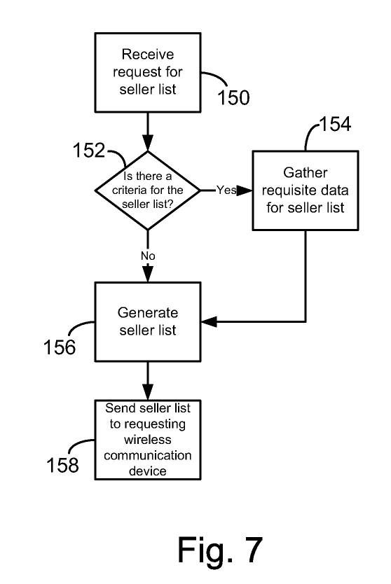

FIG. 7 is a flowchart of one embodiment of a process for a computer device, such as seller list generator 36 receiving a request for a seller list 122 for sellers of goods and/or services from a wireless communication device and the computer device generates a seller list and sends the seller list 112 to the wireless communication device. The request for the seller list 122 is received at step 150 and then a determination is made as to whether there is a predetermined criteria for generating the seller list 122, such as geographic proximity to the wireless communication device 14,16,18, or price, or fastest delivery time, or time of day, or any other criteria that may affect the desirability of the purchase of the good and/or service by the user. If there is a predetermined criteria at decision 152, then the requisite data for generating the appropriate seller list 122 is gathered, as shown at step 154, and then the seller list 122 is generated with the data, as shown at step 156. Otherwise, if there are no predetermined criteria at decision 152, then the seller list is simply generated, as shown at step 156. Then the generated seller list is sent to the requesting wireless communication device 14,16,18, as shown at step 158. The predetermined criteria can be, for example, geographic proximity of the seller to the wireless communication device (in which case the location of the wireless communication device would also need to be determined.). The predetermined criteria could also be any criteria that may impact the desirability of the user to purchase the good and/or service, such as price, time for delivery, quantity, quality, etc.

In view of the methods and processed herein being executable on a mobile device and other computer platforms, the method can accordingly be performed by a program resident in a computer readable medium, where the program directs the mobile device or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the invention has been particularly shown and described with reference to a preferred embodiment thereof, it will be understood by those skilled in the art that various changes in form and detail may be made without departing from the scope of the present invention as set forth in the following claims. Furthermore, although elements of the invention may be described or claimed in the singular, the plural is contemplated unless limitation to the singular is explicitly stated.

What is claimed is:

1. A system for purchasing a good or service through a group communication to one or more sellers, comprising:
a group communication server configured to support group communications among, at least, a plurality of wireless communication devices;
at least one wireless communication device that is configured to selectively send communications to other computer devices through the group communication server, the at least one wireless devices having a user thereof, and
at least one seller computer device that is configured to selectively receive ordering group communications from communicating wireless communication devices wherein the ordering group communications containing information on a good or service that a user of the communicating wireless communication device desires to purchase; and
wherein the at least one wireless communication device further configured to receive a seller list of one or more seller devices for the purchasing of a specific good or service such that upon the user of the at least one wireless communication device desires to purchase a good or service, the at least one wireless communication device sending an ordering group communication to the one or more seller devices based upon the seller list for one or more sellers of that good or service.

2. The system of claim 1, wherein the seller list is selectively provided to the at least one wireless communications devices by the group communication server.

3. The system of claim 1, wherein the seller list is selectively provided to the at least one wireless communications device by another computer device.

4. The system of claim 1, wherein the seller list is based upon geographic proximity of a seller to a user of the communicating wireless communication device attempting to order a good or service.

5. A method for purchasing a good or service through a group communication to one or more sellers, comprising:
creating a seller list of seller computer devices;
sending the seller list to an at least one wireless communication device by using at least one group communication server configured to support group communications among, at least, a plurality of wireless communication devices; and
sending a group communication to one or more seller computer devices from the at least one wireless communication device based upon the seller list, the group communication ordering a good or service from the seller computer devices.

6. The method of claim 5, further comprising sending a group communication from at least one seller computer device to the wireless communication device attempting to order a good or service.

7. The method of claim 5, wherein the seller list is created based upon geographic proximity of the sellers to the at least one wireless communication device attempting to order a good or service.

8. A method of supporting the purchasing of goods and services through group communications among, at least, a plurality of wireless communication device using a group communication server, comprising:
selectively sending communications to other computer devices through the group communication server, the at least one wireless device having a user thereof,
selectively receiving ordering group communications from communicating wireless communication devices wherein the ordering group communications contain information on a good or service that the user of the communicating wireless communication device desires to purchase; and
receiving a seller list of one or more seller devices for the purchasing of a specific good or service such that upon the user of the at least one wireless communication device desiring to purchase the good or service, the seller list allowing the at least one wireless communication device to selectively send an ordering group communication to the one or more seller devices based upon the seller list for one or more sellers of that good or service.

9. The method of claim 8, further comprising selectively providing to the at least one wireless communications device by the group communication server the seller list.

10. The method of claim 8, further comprising selectively providing to the at least one wireless communications device by another computer device the seller list.

11. The method of claim 8, further comprising creating the seller list based upon on geographic proximity of a seller to the user of the communicating wireless communication device attempting to order a good or service.

12. The method of claim 8, further comprising creating the seller list based upon at least one or price, time of day, or availability of the seller.

13. A computer device, comprising:
a means for creating a seller list of seller computer devices from which a user of a wireless communication device that is configured to engage in group communications can purchase a good or service through the use of a group communication to a seller computer device on the seller list; and
means for sending the seller list to at least one wireless communication device.

14. A computer-readable product, comprising:
a computer-readable medium, comprising:
a set of instructions to use a group communication server configured to support group communications among, at least, a plurality of wireless communication devices;
a set of instructions to configure at least one wireless communication device to selectively send communications to other computer devices through the group communication server, the at least one wireless device having a user thereof,
a set of instructions to configure at least one seller computer device to selectively receive ordering group communications from communicating wireless communication devices wherein the ordering group communications containing information on a good or service that the user of the communicating wireless communication device desires to purchase; and
a set of instructions to further configure the at least one wireless communication device to receive a seller list of one or more seller devices for the purchasing of a specific good or service such that upon the user of the at least one wireless communication device desiring to purchase a good or service, the at least one wireless communication device sending an ordering group communication to the one or more seller devices based upon the seller list for one or more sellers of that good or service.

15. The computer readable product of claim 14, further comprising a computer readable medium further comprising:
a set of instructions to selectively provide to the at least one wireless communication device the seller list from the group communication server.

16. The computer readable product of claim 14, further comprising a computer readable medium further comprising:
a set of instructions to selectively provide to the at least one wireless communication device the seller list from another computer device.

17. The computer readable product of claim 14, further comprising a computer readable medium further comprising:
a set of instructions for generating the seller list based on geographic proximity of a seller to the user of the communicating wireless communication device attempting to order a good or service.

18. A computer readable product comprising:
a computer-readable medium, comprising:
a set of instructions for selectively sending group communications to other computer devices through the group communication server, the at least one wireless device having a user thereof;
a set of instructions for selectively receiving ordering group communications from a wireless communication devices wherein the ordering group communications containing information on a good or service that the user of the communicating wireless communication device desires to purchase; and
a set of instructions for receiving a seller list of one or more seller devices for the purchasing of a specific good or service such that upon the user of the at least one wireless communication device desiring to purchase a good or service, the at least one wireless communication device sending an ordering group communication to the one or more seller devices based upon the seller list for one or more sellers of that good or service.

19. The computer-readable product of claim 18, further comprising a computer readable medium, further comprising:
a set of instructions for selectively providing to the at least one wireless communication device the seller list from the group communication server.

20. The computer-readable product of claim 18, further comprising a computer readable medium, further comprising:
a set of instructions for selectively providing to the at least one wireless communication device the seller list from another computer device.

21. The computer-readable product of claim 18, further comprising a computer-readable medium, further comprising:
a set of instructions for basing the seller list on geographic proximity of a seller to the user of the communicating wireless communication device attempting to order a good or service.

22. A wireless communication device, comprising:
means to request a seller list of seller computer devices from which a user of a wireless communication device that is configured to engage in group communications can purchase a good or service through the use of a group communication to a seller computer device on the seller list; and
means for sending a group communication to at least one seller computer device on the seller list.
